(19) United States
(12) Patent Application Publication
(10) Pub. No.: US 2026/0139649 A1
(43) Pub. Date: May 21, 2026

(54) VEHICLE

(71) Applicant: HONDA MOTOR CO., LTD., Tokyo (JP)

(72) Inventors: Junichi Nakano, Tokyo (JP); Makoto Hotozuka, Tokyo (JP)

(21) Appl. No.: 19/348,213

(22) Filed: Oct. 2, 2025

(30) Foreign Application Priority Data
Oct. 9, 2024 (JP) 2024-177320

(51) Int. Cl. F02M 35/10; F02M 35/08; F02M 35/12

(52) U.S. Cl. CPC F02M 35/10013; F02M 35/088; F02M 35/10124; F02M 35/1266

(57) ABSTRACT

In a vehicle including a cargo bed behind a cabin, a recess recessed forward is provided in a rear portion of the cabin, and an intake duct is accommodated in the recess.

### INCORPORATION BY REFERENCE

The present application claims priority under 35 U.S.C. § 119 to Japanese Patent Application No. 2024-177320 filed on Oct. 9, 2024. The content of the application is incorporated herein by reference in its entirety.

### BACKGROUND

### Technical Field

The present invention relates to a vehicle.

### Related Art

JP H07-007267 Y2 discloses a four-wheel buggy vehicle including a cargo bed behind a cabin, an engine arranged in a rear lower portion of a seat, and an intake duct arranged behind the cargo bed and below the cargo bed.

### SUMMARY

In the conventional configuration, a space for arranging the intake duct below the cargo bed is required, and the layout efficiency of the entire vehicle may deteriorate. In addition, in a case where an attempt is made to adopt a layout in which the intake duct is arranged not below the cargo bed but behind the cabin, there is a possibility that the layout efficiency deteriorates due to restrictions on the shape of the cabin and the arrangement of other components.

The present invention has been made in view of the above circumstances, and an object thereof is to efficiently lay out an intake duct behind a cabin.

Provided is a vehicle including a cargo bed behind a cabin, a recess recessed forward and provided in a rear portion of the cabin, and an intake duct accommodated in the recess.

According to the present invention, the intake duct can be efficiently laid out behind the cabin.

### BRIEF DESCRIPTION OF DRAWINGS

FIG. 1 is a side view of a vehicle according to an embodiment of the present invention;

FIG. 2 is a rear view of the vehicle;

FIG. 3 is a view illustrating a cabin together with a peripheral configuration from an obliquely right rear side;

FIG. 4 is a view illustrating the intake duct together with a peripheral configuration from a rear side of a vehicle body;

FIG. 5 is a view illustrating an internal structure of an air cleaner box together with a peripheral configuration;

FIG. 6 is a view illustrating a flow path bottom surface of an intake duct body;

FIG. 7 is a view illustrating a state in which a part of a cover is removed from a state in which the cover is attached to the intake duct;

FIG. 8 is a view illustrating a state in which the cover is detached from the state in which the cover is attached to the intake duct;

FIG. 9 is a view illustrating a section taken along line a1-a1 of FIG. 7, a section taken along line b1-b1 of FIG. 7, and a section taken along line c1-c1 of FIG. 7;

FIG. 10 is a view illustrating a cover according to a modification from an obliquely right rear side of a cabin; and

FIG. 11 is a view illustrating a cover according to another embodiment together with the intake duct.

### DETAILED DESCRIPTION

Hereinafter, embodiments of the present invention will be described with reference to the drawings. Note that, in the description, directions such as front, rear, left, right, up, and down are identical to directions with respect to a vehicle body, unless otherwise specified. In the drawings, reference sign FR denotes the front side of the vehicle body, reference sign UP denotes the upper side of the vehicle body, and reference sign LH denotes the left side of the vehicle body.

### EMBODIMENT

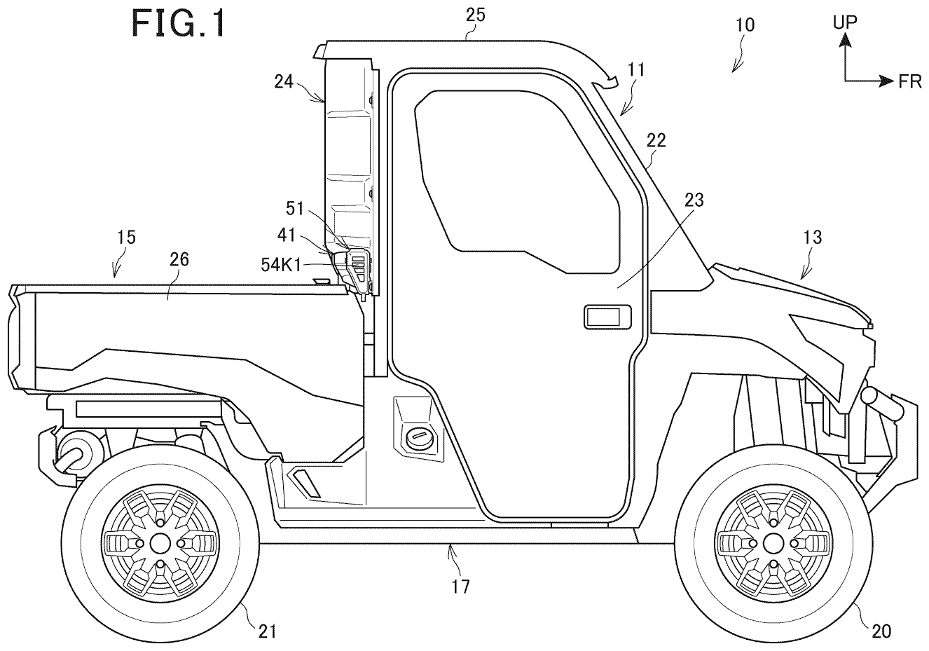

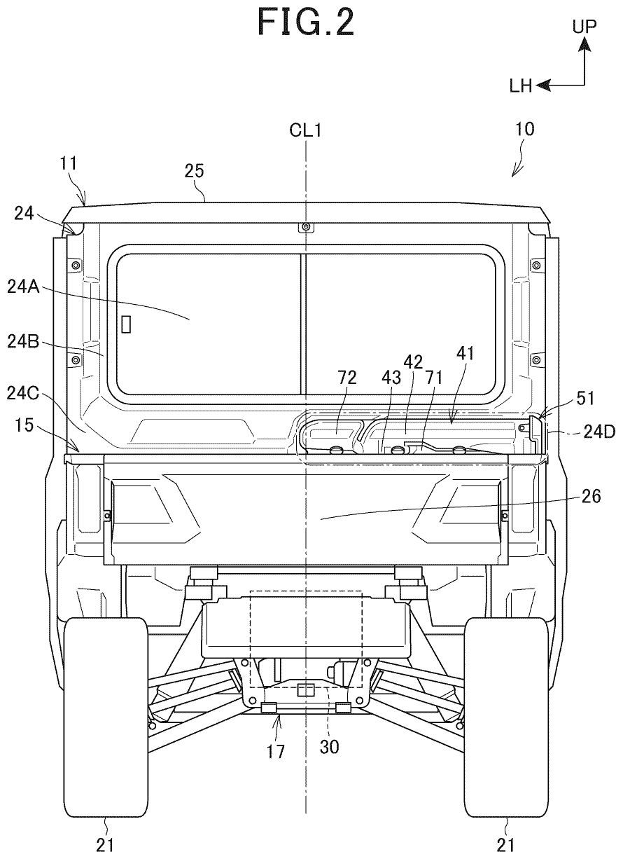

FIG. 1 is a side view of a vehicle 10 according to an embodiment of the present invention. FIG. 2 is a rear view of the vehicle 10.

The vehicle 10 includes a cabin 11 that defines a riding space for an occupant, a front body 13 provided in front of the cabin 11, a rear body 15 provided behind the cabin 11, a frame 17 extending in the front-rear direction below the cabin 11, a pair of left and right front wheels 20, and a pair of left and right rear wheels 21. The vehicle 10 is an all-terrain vehicle, more specifically, a side-by-side type multi utility vehicle (MUV). Note that the vehicle 10 may be an all-terrain vehicle other than the MUV, for example, a four-wheeled vehicle or a three-wheeled vehicle classified as ATV, or may be a vehicle other than the all-terrain vehicles.

In the cabin 11, seats on which a plurality of occupants including a driver and a passenger are seated, and an operation system such as a steering wheel are arranged. The cabin 11 is surrounded by a windshield 22 covering a front surface, a side door 23 openably covering the left and right sides of the seats, a back panel 24 covering a back surface, and a top panel 25 covering an upper surface. Note that the shape, structure, and the like of the cabin 11 may be appropriately changed, and for example, a configuration not including the side door 23 may be adopted.

A cargo bed 26 is arranged on the rear body 15. The cargo bed 26 is used as a space for placing a cargo. A rear seat may be arranged on the cargo bed 26 to enable riding of an additional occupant. The cargo bed 26 is of an open bed type and includes a side plate surrounding the periphery of the cargo bed 26. However, the shape and structure of the cargo bed 26 may be changed as appropriate.

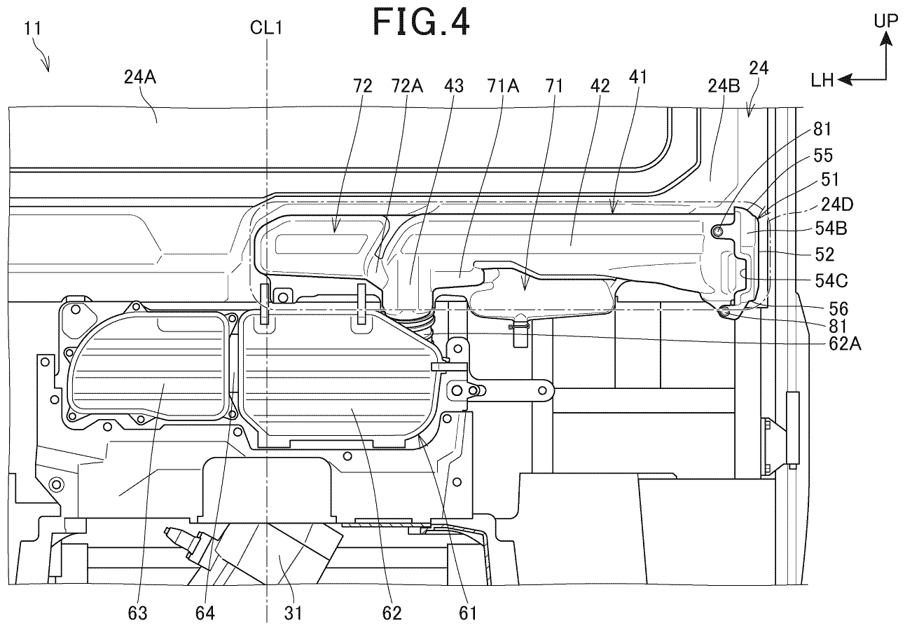

A power unit 30 (FIG. 2) for driving the vehicle is mounted on the frame 17. The power unit 30 is arranged below the rear of the cabin 11 or below the rear body 15. The power unit 30 includes an engine 31 (FIG. 4) including an internal combustion engine, and a driving force of the engine 31 is transmitted to drive wheels (the front wheels 20 and the rear wheels 21, or the rear wheels 21) via a transmission mechanism and a power transmission mechanism. Note that FIG. 2 schematically illustrates the power unit 30.

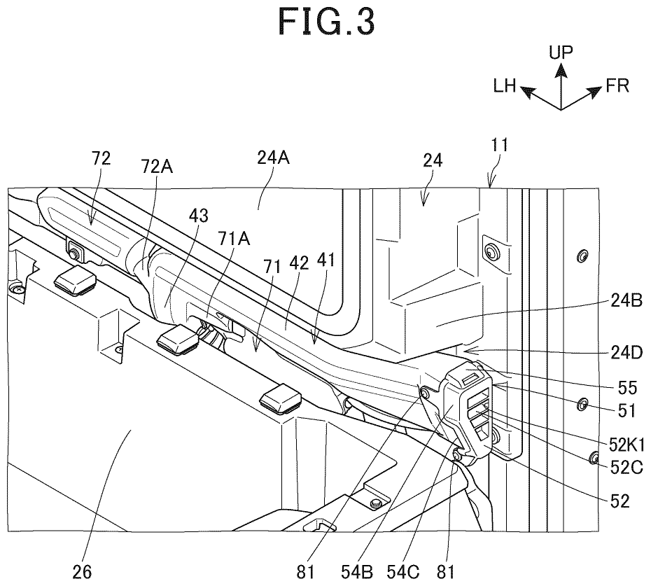

FIG. 3 is a view illustrating the cabin 11 together with a peripheral configuration from the obliquely right rear side.

As illustrated in FIGS. 2 and 3, the back panel 24 of the cabin 11 is provided with a frame-shaped opening 24B to which a rear glass 24A is attached, and the periphery of the opening 24B is formed in a recess 24C recessed to the front side of the vehicle body.

The recess 24C has a duct accommodating recess 24D that accommodates the intake duct 41. The duct accommodating recess 24D is located in a region below the opening 24B and on the right side of a vehicle widthwise center CL1, and is recessed to the front side of the vehicle body. In FIG. 2, the region of the duct accommodating recess 24D is indicated by an alternate long and short dash line.

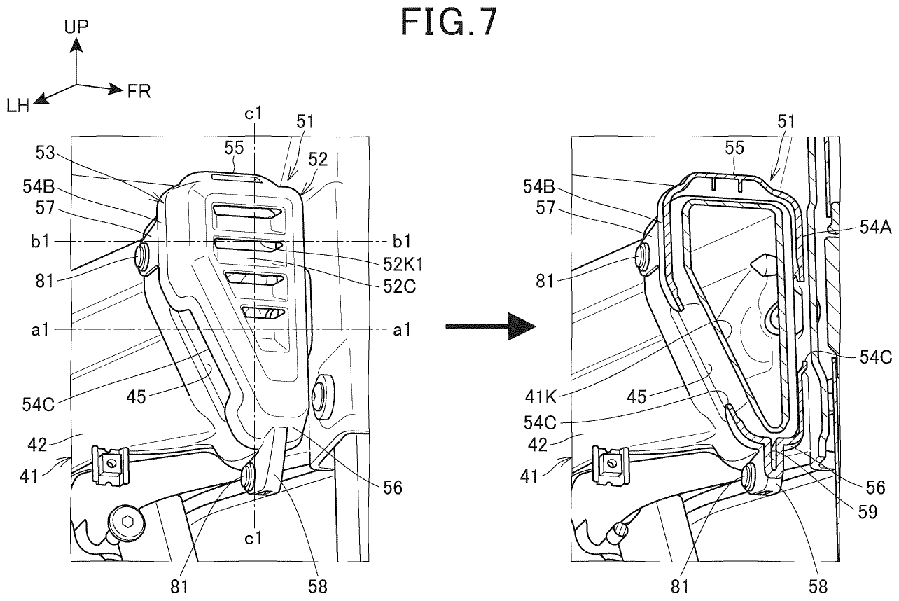

As illustrated in FIG. 3, the intake duct 41 extends outward in a vehicle width direction along a lower edge of the opening 24B and is accommodated in the duct accommodating recess 24D. As a result, the intake duct 41 is accommodated in a space below the opening 24B, behind the back panel 24, and in front of the cargo bed 26. A cover 51 that covers an air inlet 41K (FIG. 7) of the intake duct 41 is attached to an outer end of the intake duct 41 in the vehicle width direction.

As illustrated in FIG. 3, since the intake duct 41 is arranged in front of the cargo bed 26, the cargo mounted on the cargo bed 26 does not come into contact with the intake duct 41. In addition, since the opening 24B protruding rearward is located above the intake duct 41, scattered objects such as rainwater and mud from above are less likely to be caught on the intake duct 41. Further, the intake duct 41 is located immediately below the opening 24B, and is arranged at a relatively high position where maintenance work is easy.

FIG. 4 is a view illustrating the intake duct 41 together with a peripheral configuration from the rear side of the vehicle body. Note that FIG. 4 does not illustrate the cargo bed 26.

As illustrated in FIG. 4, the engine 31 is arranged at the vehicle widthwise center and on the lower side of the vehicle 10 in a vehicle body rear view. An air cleaner box 61 is arranged above the engine 31 in the vehicle body rear view. The air cleaner box 61 includes a first box 62 to which air from the intake duct 41 is supplied, a second box 63 connected to an intake port of the engine 31 via a throttle body, and a communication pipe 64 that communicates between the first box 62 and the second box 63. The air cleaner box 61 may be simply referred to as an air cleaner.

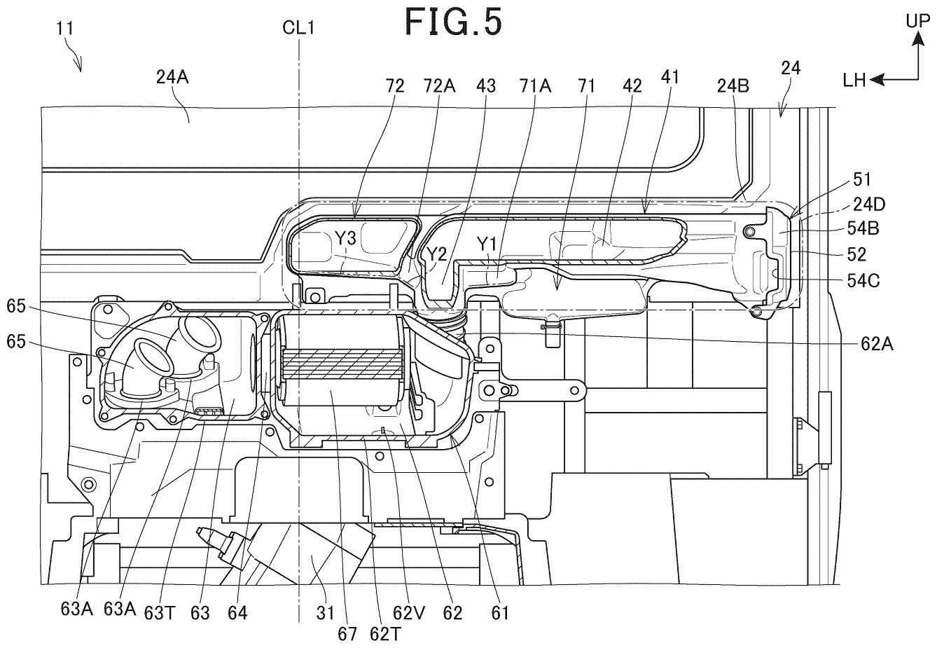

FIG. 5 is a view illustrating an internal structure of the air cleaner box 61 together with a peripheral configuration.

The second box 63 is arranged on the left side with respect to the vehicle widthwise center CL1 (on a side opposite to the duct accommodating recess 24D in the vehicle width direction), and forms a so-called clean air chamber. A bottom 63T of the second box 63 is provided with pedestals 63A protruding upward, and funnels 65 are connected so as to penetrate upper surfaces of the pedestals 63A in the up-down direction. An upper portion of the funnel 65 is opened inside the second box 63, and a lower portion of the funnel 65 is coupled to the throttle body.

Since the funnels 65 are connected to the pedestals 63A, even if water enters the second box 63, the water remains at a position lower than the upper surfaces of the pedestals 63A, and the water is suppressed from entering sites where the funnels 65 are connected to the second box 63.

The first box 62 is arranged side by side on the right side (on the duct accommodating recess 24D side in the vehicle body rear view) with respect to the second box 63, and forms a so-called intake air chamber. The first box 62 is provided with an intake duct connection portion 62A extending upward on a side opposite to the second box 63, and the intake duct 41 is connected to the intake duct connection portion 62A. Further, an air filter 67 is accommodated in the first box 62, and air purified by the air filter 67 is supplied to the second box 63 through the communication pipe 64.

The communication pipe 64 is arranged so as to extend horizontally along the vehicle width direction, and is arranged above a bottom 62T of the first box 62 and the bottom 63T of the second box 63. As a result, even if water enters the first box 62, the water hardly enters the communication pipe 64, so that the movement of water from the first box 62 to the second box 63 can be prevented. In addition, even if water enters the second box 63, the water hardly enters the communication pipe 64, so that the movement of water from the second box 63 to the first box 62 can also be prevented.

A drain valve 62V is provided at the bottom 62T of the first box 62. The drain valve 62V enables water having entered the first box 62 to be promptly discharged to the outside of the first box 62. As illustrated in FIG. 5, the air filter 67, the communication pipe 64, and the bottom 63T of the second box 63 are provided above the drain valve 62V. That is, the drain valve 62V is provided at the lowermost portion of the air cleaner box 61, and can promptly discharge the water flowing to the lowermost portion.

The intake duct 41 and intake duct-related components will be further described.

As illustrated in FIGS. 4 and 5, the intake duct 41 includes an intake duct body 42 extending in the vehicle width direction along the duct accommodating recess 24D, and a bent portion 43 having a tubular shape and bent downward from a downstream end (an inner end in the vehicle width direction) of the intake duct body 42.

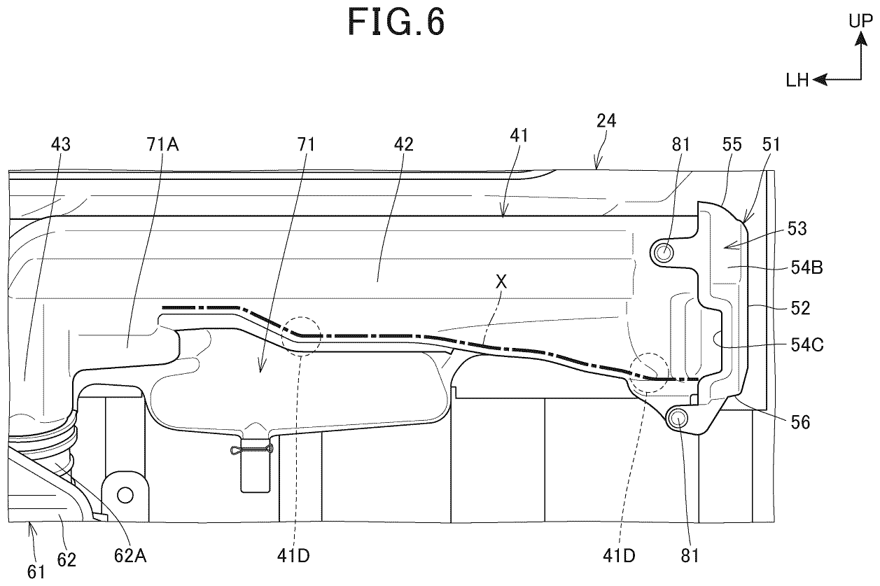

In FIG. 6, a flow path bottom surface of the intake duct body 42 is indicated by an alternate long and short dash line X.

As illustrated in FIG. 6, the flow path bottom surface X of the intake duct 41 has an inclined shape that gradually descends toward the air inlet 41K (FIG. 7) at the outer end in the vehicle width direction (the cover 51 side). Therefore, even if water enters the intake duct 41, the water can be made to flow toward the air inlet 41K.

The flow path bottom surface X of the intake duct 41 includes step portions 41D in which the height changes stepwise at an interval in a longitudinal direction (the vehicle width direction). The fact that the height changes stepwise can also be referred to as a shape in which the height changes stepwise or a shape in which the angle changes steeply in the up-down direction. If water enters the intake duct 41, it is difficult for the water to pass over the step portion 41D, so that the movement of water to the downstream side of the intake duct 41 can be effectively prevented. As a result, it is possible to suppress a situation in which water moves to the downstream side of the intake duct 41 even when the lateral G is applied during traveling.

Next, a resonator (a first resonator 71 and a second resonator 72) connected to the intake duct 41 will be described with reference to FIGS. 4 and 6.

As illustrated in FIG. 4, the first resonator 71 is arranged below the intake duct body 42 and on the outer side in the vehicle width direction of the bent portion 43. The first resonator 71 is arranged at a position overlapping the duct accommodating recess 24D provided on the back panel 24 in the vehicle body rear view. That is, the first resonator 71 is arranged using a space in the duct accommodating recess 24D, the space being provided below the intake duct body 42 and the outer side in the vehicle width direction of the bent portion 43.

As illustrated in FIG. 6, since the flow path bottom surface X of the intake duct 41 has the inclined shape that descends to the upstream side (the outer end in the vehicle width direction) in the present configuration, a space toward the upper side becomes wider as proceeding to the downstream side. The first resonator 71 is arranged by effectively using the space toward the upper side.

The first resonator 71 is connected to the bent portion 43 via a connection pipe 71A directed to the inner side in the vehicle width direction which corresponds to the downstream side of the intake duct 41. The first resonator 71 is configured as a resonator that reduces intake noise using the principle of resonance. As a result, the intake noise generated in the bent portion 43 can be effectively reduced.

In FIG. 5, a flow path bottom surface of the connection pipe 71A is indicated by an alternate long and short dash line Y1. The flow path bottom surface Y1 of the connection pipe 71A has an inclined shape gradually descending toward the intake duct 41, so that water entering from the intake duct 41 side promptly returns to the intake duct 41 side without being stagnant. As a result, a structure in which water hardly enters the first resonator 71 is obtained.

As illustrated in FIGS. 4 and 5, the second resonator 72 is arranged on a side opposite to the first resonator 71 across the intake duct 41. The second resonator 72 is arranged at a position overlapping the duct accommodating recess 24D provided on the back panel 24 in the vehicle body rear view. That is, the second resonator 72 is arranged using a space in the duct accommodating recess 24D, the space being provided on the inner side in the vehicle width direction with respect to the intake duct body 42 and above the air cleaner box 61. The second resonator 72 is arranged above the air cleaner box 61 and overlaps the air cleaner box 61 in the up-down direction.

The second resonator 72 is connected to the bent portion 43 via a connection pipe 72A directed to the outer side in the vehicle width direction. Similarly to the first resonator 71, the second resonator 72 is configured as a resonator that reduces the intake noise using the principle of resonance. As described above, the intake noise generated in the bent portion 43 can be effectively reduced by the plurality of resonators 71 and 72. Since the bent portion 43 is a portion where the intake noise is easily amplified, the intake noise of the intake duct 41 can be effectively reduced. Further, since the driver's seat of the vehicle 10 is on the left side and the intake duct 41 is arranged on the right side, the intake noise is less likely to be transmitted to the driver's seat, which is advantageous for improving the comfort of the occupant.

In FIG. 5, a flow path bottom surface of the connection pipe 72A is indicated by an alternate long and short dash line Y2, and a bottom surface of the second resonator 72 is indicated by an alternate long and short dash line Y3. The flow path bottom surface Y2 of the connection pipe 72A has an inclined shape that gradually descends toward the intake duct 41, and the bottom surface Y3 of the second resonator 72 has an inclined shape that gradually descends toward the connection pipe 72A. This results in a structure in which water hardly enters the second resonator 72 since water entering from the intake duct 41 side promptly returns to the intake duct 41 side without being stagnant.

Next, the air inlet 41K of the intake duct 41 and the cover 51 will be described with reference to FIGS. 7 to 9.

FIG. 7 is a view illustrating a state in which the cover 51 is partially removed from a state in which the cover 51 is attached to the intake duct 41. The cover 51 is detachably fixed to the outer end (right end) in the vehicle width direction of the intake duct 41 by fastening members 81. When the cover 51 is detached, the air inlet 41K formed at the outer end in the vehicle width direction of the intake duct 41 is exposed.

The air inlet 41K is formed in a downward projecting opening shape whose width (corresponding to the front-rear length in the present configuration) gradually narrows downward. Therefore, when water enters the air inlet 41K from the outside, the water can be collected at a narrow site in a lower portion.

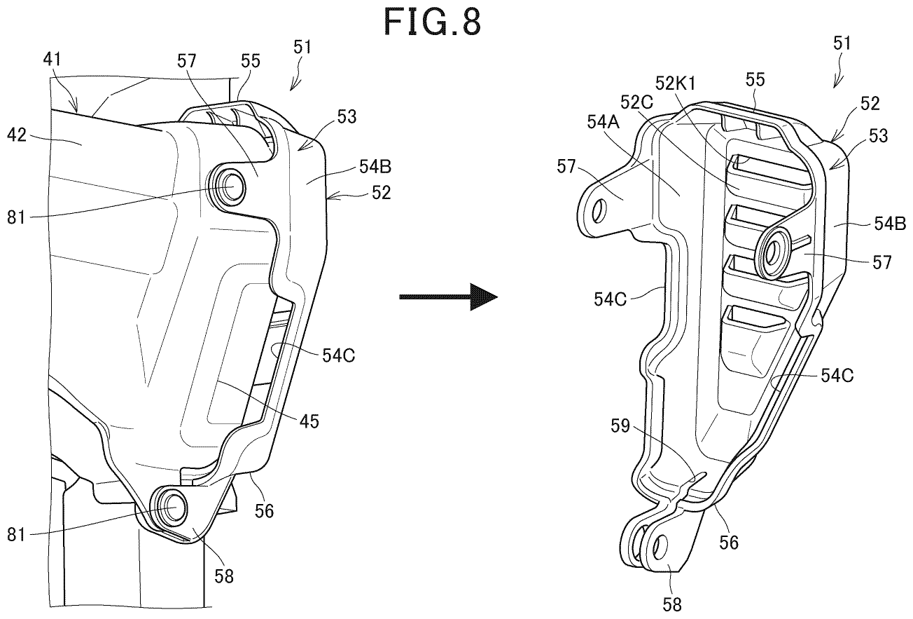

FIG. 8 is a view illustrating a state in which the cover 51 is detached from the state in which the cover 51 is attached to the intake duct 41.

The cover 51 integrally includes a cover body 52 having a flat plate shape and covering the air inlet 41K from the outer side in the vehicle width direction, and a peripheral wall 53 (hereinafter, the cover peripheral wall 53) extending from an outer edge of the cover body 52 so as to cover the intake duct 41 from the left, right, above, and below. The cover peripheral wall 53 includes left and right side plates 54A and 54B (hereinafter, the cover side plates 54A and 54B), an upper plate 55 (hereinafter, the cover upper plate 55) that bridges between upper ends of the left and right cover side plates 54A and 54B, and a lower plate 56 (hereinafter, the cover lower plate 56) that bridges between lower ends of the left and right cover side plates 54A and 54B.

The cover body 52 includes a first opening 52K1 facing the air inlet 41K. The first opening 52K1 is provided with inclined cover portions 52C inclined downward and toward the opening outer side at intervals in the up-down direction. As a result, external air can be smoothly supplied into the intake duct 41 from a side facing the air inlet 41K. In addition, since water (for example, rainwater) from the side facing the air inlet 41K can be guided to the outside and the lower side by the inclined cover portions 52C, the entry of water into the cover 51 can be suppressed.

The cover side plates 54A and 54B constituting left and right portions of the cover 51 are respectively provided with stays 58 fastened to the intake duct 41 by the fastening members 81. The lower plate of the cover 51 is also provided with left and right stays 58 fastened to the intake duct 41 by the fastening members 81. The left and right stays 58 extend downward from the cover lower plate 56, and a groove 59 communicating with a gap between the left and right stays 58 is formed in the cover lower plate 56.

Water that has entered the air inlet 41K flows into the groove 59, thereby discharging the water to the outside of the cover 51. That is, the groove 59 functions as a drain.

The left and right cover side plates 54A and 54B are respectively provided with cutout portions 54C (hereinafter, the cover-side cutout portions 54C) cut out on the cover body 52 side.

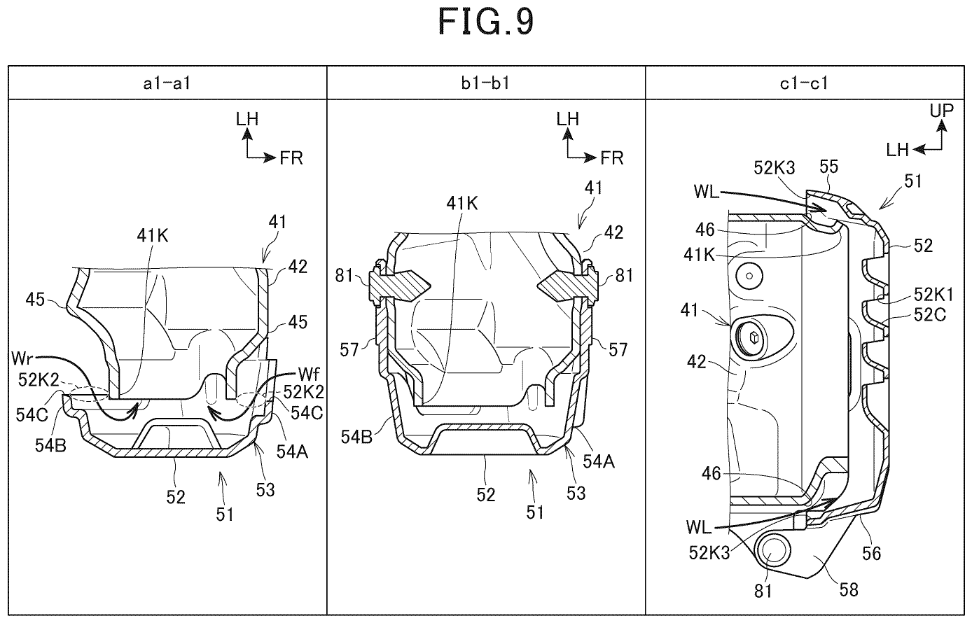

FIG. 9 illustrates a view illustrating a section taken along line a1-a1 of FIG. 7, a section taken along line b1-b1 of FIG. 7, and a section taken along line c1-c1 of FIG. 7. In FIG. 9, flows of air from the outside are denoted by reference signs Wr, Wf, and WL, respectively.

As illustrated in the section taken along the line a1-a1 in FIG. 9, the left and right cover-side cutout portions 54C form a pair of second openings 52K2 for introducing the air Wf from the front side of the vehicle body and the air Wr from the rear side of the vehicle body into the air inlet 41K. The second opening 52K2 is formed in each of the cover side plates 54A and 54B, so as to be positioned at the front side of the vehicle body and the rear side of the vehicle body of the cover 51.

As illustrated in the section taken along the line b1-b1 in FIG. 9, in regions of the cover side plates 54A and 54B where the left and right cover-side cutout portions 54C are not formed, no opening is formed between the cover side plates 54A and 54B and the intake duct 41.

As illustrated in the section taken along the line c1-c1 in FIG. 9, each of the cover upper plate 55 and the cover lower plate 56 is formed in a shape with a gap opened against the intake duct 41 in a direction opposite to the first opening 52K1. As a result, a pair of third openings 52K3 for introducing the air WL from the inner side in the vehicle width direction into the air inlet 41K is formed.

The second openings 52K2 and the third openings 52K3 can be referred to as openings formed in the cover 51, and the openings 52K2 and 52K3 are formed at positions different from the first opening 52K1 and opened to the outside in directions different from the first opening 52K1. As a result, air can be taken into the intake duct 41 from a plurality of directions through the first opening 52K1, the second openings 52K2, and the third openings 52K3, which is advantageous for increasing the amount of intake air.

As illustrated in FIG. 7 and the section taken along the line a1-a1 in FIG. 9, the intake duct 41 includes a protruding portion 45 in the periphery of each of the second openings 52K2. The protruding portions 45 protrude in the front-rear direction on the opening outer side of the second openings 52K2, thereby making it difficult for water from the outside to enter the second openings 52K2.

As illustrated in the section taken along the line c1-c1, the intake duct 41 includes a protruding portion 46 in the periphery of each of the third openings 52K3. The protruding portions 46 protrude upward and downward, respectively, so as to narrow openings of the third openings 52K3, thereby making it difficult for water from the outside to enter the third openings 52K3.

As described above, the vehicle 10 of the present embodiment includes the duct accommodating recess 24D recessed forward and provided in a rear portion of the cabin 11, and the intake duct 41 is accommodated in the duct accommodating recess 24D. According to this configuration, since the intake duct 41 does not protrude from the cabin 11, the intake duct 41 can be efficiently laid out behind the cabin 11. When a cargo is loaded on the cargo bed 26, the cargo does not come into contact with the intake duct 41. Note that the duct accommodating recess 24D corresponds to an example of a recess of the present disclosure.

In addition, the flow path bottom surface X of the intake duct 41 has the inclined shape that gradually descends toward the air inlet 41K provided at the end of the intake duct 41. As a result, even when water enters the intake duct 41, the water can be discharged from the air inlet 41K.

The flow path bottom surface X of the intake duct 41 has the step portions 41D in which the height changes stepwise, and the first resonator 71 is arranged in the space formed below the intake duct 41 as the flow path bottom surface X of the intake duct 41 descends toward the air inlet 41K. The step portions 41D can suppress a situation where water that has entered the intake duct 41 enters the depth even when the lateral G is applied during traveling. The intake duct 41 and the first resonator 71 can be compactly arranged, and the first resonator 71 can be efficiently laid out in the vicinity of the rear of the cabin 11.

In addition, the cover 51 that covers the air inlet 41K is provided, and the groove 59 that functions as the drain is provided in the lower portion of the cover 51. As a result, water that has entered the air inlet 41K can be discharged from the lower portion of the cover 51.

In addition, the width of the intake duct 41 gradually narrows downward. As a result, water that has entered the intake duct 41 can be smoothly discharged from the groove 59 of the cover 51.

The cover 51 includes the first opening 52K1 facing the air inlet 41K, and the first opening 52K1 is provided with the inclined cover portion 52C inclined downward toward the opening outer side. As a result, it is possible to suppress the entry of rainwater or the like. Since the first openings 52K1 face the air inlet 41K, air can be efficiently taken inside.

In addition, the cover 51 includes the second openings 52K2 at sites different from the first opening 52K1, and the second openings 52K2 are respectively provided on the front side and the rear side of the vehicle body with respect to the first opening 52K1. As a result, it is possible to increase the amount of intake air as compared with a case where only the first opening 52K1 is provided. Further, rainwater or the like can be suppressed from entering the second openings during traveling since the second openings are respectively provided on the front side and the rear side of the vehicle body behind the cabin 11. The amount of intake air can be increased by providing the second opening 52K2 on at least one of the front side and the rear side of the vehicle body with respect to the first opening 52K1.

The cover 51 includes the third openings 52K3 that are opened to the outside in a direction opposite to the first opening 52K1. As a result, the amount of intake air can be increased by the third openings 52K3. The third openings 52K3 are opened to the inner side in the vehicle width direction behind the cabin 11, so that rainwater or the like can be suppressed from entering the third openings 52K3.

In addition, the intake duct 41 includes the protruding portion 45 provided in the periphery of each of the second openings 52K2 and protruding so as to be able to suppress the entry of water from the outside. As a result, the protruding portions 45 can suppress rainwater or the like from entering the second openings 52K2.

In addition, the intake duct 41 includes the protruding portion 46 provided in the periphery of each of the third openings 52K3 and protruding so as to be able to suppress the entry of water from the outside. As a result, the protruding portions 46 can suppress rainwater or the like from entering the third openings 52K3.

The intake duct 41 includes the intake duct body 42 having the air inlet 41K at one end in the longitudinal direction, the bent portion 43 at the other end in the longitudinal direction of the intake duct body 42, and the first resonator 71 is connected to the bent portion 43. As a result, the intake noise generated in the bent portion 43 where the intake noise is easily amplified can be effectively reduced. The intake duct 41 can be efficiently laid out using the space formed between the intake duct body 42 and the bent portion 43.

In addition, the second resonator 72 which is another resonator connected to the bent portion 43 is provided, and the second resonator 72 is arranged on the side opposite to the first resonator 71 across the intake duct 41. As a result, since the plurality of resonators 71 and 72 are connected to the bent portion 43, the intake noise can be effectively reduced. In addition, the plurality of resonators 71 and 72 can be efficiently laid out using the spaces formed on both sides of the intake duct 41.

The bent portion 43 is connected to the air cleaner box 61, and the air cleaner box and the second resonator 72 overlap each other in the up-down direction of the vehicle body. As a result, the air cleaner box 61 and the second resonator 72 can be compactly arranged, and can be efficiently laid out.

The air cleaner box 61 includes the first box 62 to which the air from the intake duct 41 is supplied, the drain valve 62V provided in the bottom 62T of the first box 62 to discharge entering water, and the second box 63 provided downstream of the first box 62 and connected to the first box 62 via the communication pipe 64. The bottom 63T of the second box 63 is arranged above the drain valve 62V, and the communication pipe 64 is arranged above the bottom 62T of the first box 62. As a result, the water that has entered the first box 62 can be discharged. In addition, the water in the first box 62 hardly enters the second box 63.

The funnels 65 are provided in the second box 63, and the funnels 65 are connected to the second box 63 above the bottom 63T of the second box 63. As a result, even when water enters and accumulates in the second box 63, it is possible to suppress the water from infiltrating into connection portions between the funnels 65 and the second box 63.

In addition, the vehicle 10 is the all-terrain vehicle, and can prevent water from entering an intake system including the intake duct 41 and the air cleaner box 61 although the water may be splashed thereon during traveling on rough terrains. Further, since the intake noise is reduced, noise transmitted to the occupants from the intake duct 41 arranged in the duct accommodating recess 24D behind the cabin 11 is also suppressed. Therefore, it is possible to realize the all-terrain vehicle that achieves both prevention of entry of water into the intake system and reduction of intake noise.

### Another Embodiment

The above-described embodiment merely describes one aspect of the present invention, and can be optionally modified and applied without departing from the gist of the present invention.

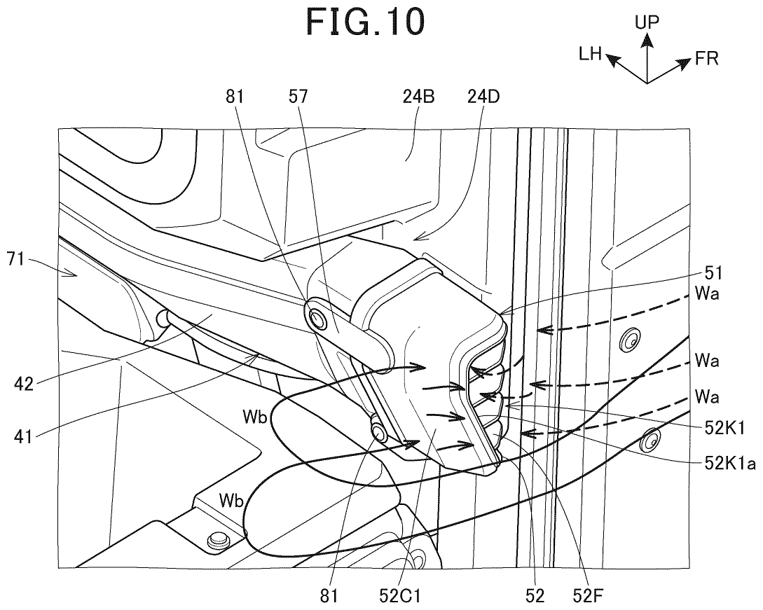

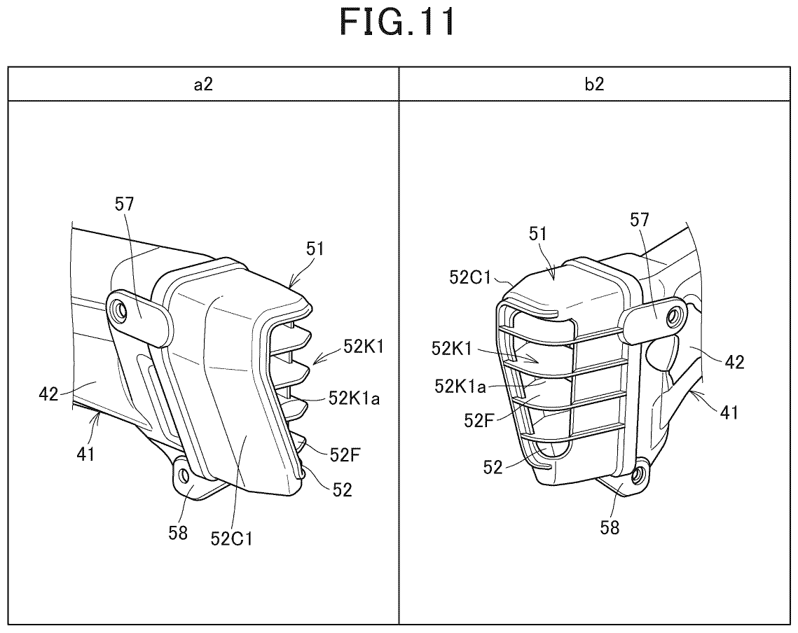

For example, the shape of the cover 51 may be changed to a shape illustrated in FIGS. 10 and 11. FIG. 10 is a view illustrating the cover 51 according to another embodiment from the obliquely right rear side of the cabin 11. FIG. 10 schematically illustrates flows of the traveling winds Wa and Wb during traveling of a vehicle.

FIG. 11 is a view illustrating the cover 51 according to another embodiment together with the intake duct 41. Reference sign a2 in FIG. 11 is a view illustrating the intake duct 41 from the right rear side, and reference sign b2 is a view illustrating the intake duct 41 from the right front side.

As illustrated in FIGS. 10 and 11, the cover 51 according to another embodiment includes, as the first opening 52K1 facing the air inlet 41K, an oblique front air inlet 52K1a continuously extending from the outer side in the vehicle width direction to the front side of the vehicle body, and a rear cover portion 52C1 covering the oblique front air inlet 52K1a from the rear side. In addition, in the cover 51 according to the modification, fins 52F extending horizontally are provided in the first opening 52K1 at an interval in the up-down direction. Note that the same components as those of the cover 51 of the above embodiment are denoted by the same reference signs, and redundant description will be omitted.

As illustrated in FIG. 10, in the periphery of the cover 51, the traveling air Wb swirling to the front side from the rear side of the cabin 11 is generated, in addition to the traveling air Wa flowing rearward on the lateral side of the cabin 11 from the front side of the vehicle body.

Since the cover 51 of the modification includes the obliquely front air inlet 52K1a continuously extending from the outer side in the vehicle width direction to the front side of the vehicle body, air (traveling air Wa) between the cover and the cabin 11 can be preferentially taken inside. This air can be smoothly guided into the cabin 11 by the fins 52F, and entry of foreign matter can be prevented. Further, since the cover 51 is not opened obliquely rearward or rearward, the rear cover portion 52C1 can suppress entry of the traveling air Wb swirled from the rear. As a result, entry of dust and water at a position distant from the cabin 11 can be suppressed.

Note that, in the cover 51 illustrated in FIGS. 10 and 11, instead of the horizontally extending fins 52F, the inclined cover portions 52C inclined downward and toward the opening outer side may be provided at an interval in the up-down direction. Since water (for example, rainwater) from the outside can be guided to the outside and the lower side by the inclined cover portion 52C, the entry of water into the cover 51 can be further suppressed. Note that the inclined cover portion 52C can also be referred to as an inclined fin.

Although the case where the present invention is applied to an intake duct structure of the vehicle 10 illustrated in FIG. 1 and the like has been described, the present invention is not limited thereto, and may be applied to intake duct structures of other vehicles. Further, the shape and structure of each part of the intake duct 41 may be appropriately changed, and for example, the number, shapes, and positions of resonators (the first resonator 71 and the second resonator 72) may be changed, or a configuration without any resonator may be adopted.

### Configurations Supported by Above Embodiments

The embodiments described above support the following configurations.

(Configuration 1) A vehicle including a cargo bed behind a cabin, in which a recess recessed forward is provided in a rear portion of the cabin, and an intake duct is accommodated in the recess.

According to this configuration, the intake duct can be efficiently laid out behind the cabin.

(Configuration 2) The vehicle according to Configuration 1, in which a flow path bottom surface of the intake duct has an inclined shape gradually descending toward an air inlet provided at an end of the intake duct.

According to this configuration, even when water enters the intake duct, the water can be discharged from the air inlet.

(Configuration 3) The vehicle according to Configuration 2, in which the flow path bottom surface of the intake duct has a step portion whose height changes stepwise, and a resonator is arranged in a space formed below the intake duct as the flow path bottom surface of the intake duct descends toward the air inlet.

According to this configuration, the step portion can suppress a situation where water that has entered the intake duct 41 enters the depth even when the lateral G is applied during traveling. The intake duct 41 and the first resonator 71 can be compactly arranged, and the first resonator 71 can be efficiently laid out in the vicinity of the rear of the cabin 11.

(Configuration 4) The vehicle according to Configuration 2 or 3, further including a cover that covers the air inlet, and a drain in a lower portion of the cover.

According to this configuration, water that has entered the air inlet can be discharged from the lower portion of the cover.

(Configuration 5) The vehicle according to Configuration 4, in which a width of the intake duct gradually narrows downward.

According to this configuration, water that has entered the intake duct can be smoothly discharged from the drain of the cover.

(Configuration 6) The vehicle according to any one of Configurations 3 to 5, in which the cover includes a first opening facing the air inlet, and the first opening is provided with an inclined cover portion inclined downward toward an opening outer side and an inclined front air inlet continuously extending from an outer side in a vehicle width direction to a front side of a vehicle body.

According to this configuration, it is possible to suppress entry of rainwater or the like by the inclined cover portion while efficiently taking in air through the first opening facing the air inlet. In addition, since the cover is not opened obliquely rearward or rearward while effectively taking in air flowing rearward on a lateral side of the cabin through the obliquely front air inlet, it is possible to suppress entry of dust and water contained in traveling air or the like swirled from the rear.

(Configuration 7) The vehicle according to any one of Configurations 2 to 6, in which the cover includes a first opening facing the air inlet and a second opening at a site different from the first opening, and the second opening is provided at least one of a front side and a rear side of a vehicle body with respect to the first opening.

According to this configuration, it is possible to increase the amount of intake air as compared with a case where only the first opening is provided. Further, water or the like can be suppressed from entering the second opening during traveling since the second opening is provided on the front side and/or the rear side of the vehicle body behind the cabin.

(Configuration 8) The vehicle according to Configuration 6 or 7, in which the cover includes a third opening that is opened to the outside in a direction opposite to the first opening.

According to this configuration, the amount of intake air can be increased by the third opening. In addition, since the third opening is opened to the inner side in the vehicle width direction behind the cabin, it is possible to suppress entry of water or the like into the third opening.

(Configuration 9) The vehicle according to Configuration 8, in which the intake duct includes a protruding portion in the periphery of the second opening and/or the third opening.

According to this configuration, it is possible to suppress entry of water into the second opening and/or the third opening by the protruding portion.

(Configuration 10) The vehicle according to any one of Configurations 2 to 9, in which the intake duct includes an intake duct body having the air inlet at one end in a longitudinal direction and a bent portion provided at another end in the longitudinal direction of the intake duct body, and the resonator is connected to the bent portion.

According to this configuration, intake noise generated in the bent portion where the intake noise is easily amplified can be effectively reduced.

(Configuration 11) The vehicle according to Configuration 10, further including another resonator connected to the bent portion, in which the another resonator is arranged on a side opposite to the resonator across the intake duct.

According to this configuration, since a plurality of the resonators are connected to the bent portion, the intake noise can be effectively reduced. In addition, the plurality of resonators can be efficiently laid out using spaces formed on both sides of the intake duct.

(Configuration 12) The vehicle according to Configuration 11, in which the bent portion is connected to an air cleaner box, and the air cleaner box and the another resonator overlap each other in an up-down direction of a vehicle body.

According to this configuration, the air cleaner box and the second resonator can be compactly arranged, and can be efficiently laid out.

(Configuration 13) The vehicle according to Configuration 12, in which the air cleaner box includes a first box to which air from the intake duct is supplied, a drain valve provided at a bottom of the first box to discharge entering water, and a second box provided downstream of the first box and connected to the first box via a communication pipe, and a bottom of the second box is arranged above the drain valve, and the communication pipe is arranged above the bottom of the first box.

According to this configuration, water that has entered the first box can be discharged. In addition, the water in the first box hardly enters the second box.

(Configuration 14) The vehicle according to Configuration 13, further including a funnel in the second box, in which the funnel is connected to the second box above the bottom of the second box.

According to this configuration, even when water enters and accumulates in the second box, it is possible to suppress the water from infiltrating into a connection portion between the funnel and the second box.

### REFERENCE SIGNS LIST

10 Vehicle
11 Cabin
24D Duct accommodating recess
26 Cargo bed
41 Intake duct
41K Air inlet
41D Step portion
42 Intake duct body
43 Bent portion
45, 46 Protruding portion
51 Cover
52K1 First opening
52K1a Oblique front air inlet
52K2 Second opening
52K3 Third opening
52C Inclined cover portion
59 Groove (drain)
61 Air cleaner box
62 First box
63 Second box
64 Communication pipe
65 Funnel
71 First resonator
72 Second resonator (another resonator)

What is claimed is:

1. A vehicle comprising:
a cargo bed behind a cabin;
a recess recessed forward and provided in a rear portion of the cabin; and
an intake duct accommodated in the recess.

2. The vehicle according to claim 1, wherein a flow path bottom surface of the intake duct has an inclined shape gradually descending toward an air inlet provided at an end of the intake duct.

3. The vehicle according to claim 2, wherein
the flow path bottom surface of the intake duct has a step portion whose height changes stepwise, and
the vehicle further comprising a resonator arranged in a space formed below the intake duct as the flow path bottom surface of the intake duct descends toward the air inlet.

4. The vehicle according to claim 3, further comprising:
a cover covering the air inlet; and
a drain provided in a lower portion of the cover.

5. The vehicle according to claim 4, wherein a width of the intake duct gradually narrows downward.

6. The vehicle according to claim 5, wherein
the cover includes a first opening facing the air inlet, and
the first opening is provided with an inclined cover portion inclined downward toward an opening outer side and an inclined front air inlet continuously extending from an outer side in a vehicle width direction to a front side of a vehicle body.

7. The vehicle according to claim 2, wherein
the cover includes a first opening facing the air inlet and a second opening at a site different from the first opening, and
the second opening is provided on at least one of a front side and a rear side of a vehicle body with respect to the first opening.

8. The vehicle according to claim 7, wherein the cover includes a third opening that is opened to an outside in a direction opposite to the first opening.

9. The vehicle according to claim 8, wherein the intake duct includes a protruding portion in a periphery of the second opening and/or the third opening.

10. The vehicle according to claim 3, wherein
the intake duct includes an intake duct body having the air inlet at one end in a longitudinal direction, and a bent portion at another end in the longitudinal direction of the intake duct body, and
the resonator is connected to the bent portion.

11. The vehicle according to claim 10, further comprising another resonator connected to the bent portion,
wherein the another resonator is arranged on a side opposite to the resonator across the intake duct.

12. The vehicle according to claim 11, further comprising an air cleaner box to which the bent portion is connected,
wherein the air cleaner box and the another resonator overlap each other in an up-down direction of a vehicle body.

13. The vehicle according to claim 12, wherein
the air cleaner box includes
a first box to which air from the intake duct is supplied,
a drain valve provided at a bottom of the first box to discharge entering water, and
a second box provided downstream of the first box and connected to the first box via a communication pipe,
a bottom of the second box is arranged above the drain valve, and
the communication pipe is arranged above the bottom of the first box.

14. The vehicle according to claim 13, further comprising a funnel provided in the second box,
wherein the funnel is connected to the second box above the bottom of the second box.
